(19) United States
(12) Patent Application Publication
(10) Pub. No.: US 2025/0335262 A1
(43) Pub. Date: Oct. 30, 2025

(54) SYSTEM TO OPTIMIZE THE INSTANCE SIZE AND CLUSTER SIZE FOR JOBS RUNNING ON DISTRIBUTED COMPUTING CLUSTERS

(71) Applicant: Sync Computing Corp., Cambridge, MA (US)

(72) Inventors: Sean Gorsky, Somerville, MA (US); Aditya Jaishankar, Somerset, NJ (US); Cayman Williams, Mesa, AZ (US)

(21) Appl. No.: 19/190,350

(22) Filed: Apr. 25, 2025

Related U.S. Application Data
(60) Provisional application No. 63/639,512, filed on Apr. 26, 2024.

(51) Int. Cl. G06F 9/50

(52) U.S. Cl. CPC G06F 9/505

(57) ABSTRACT

A method for optimizing a workflow provided to a cloud computing system is described. The method includes extracting information from at least one log file for a job. The log file(s) are for at least one run of the job (e.g., correspond to a run of the job). The method also includes determining a recommended allocation of cloud resources for the job based on the information from the log file(s). The recommended allocation of the cloud resources includes an incremental change from a most recent allocation of cloud resources.

### CROSS REFERENCE TO OTHER APPLICATIONS

This application claims priority to U.S. Provisional Patent Application No. 63/639,512 entitled SY STEM TO OPTIMIZE THE INSTANCE SIZE AND CLUSTER SIZE FOR SPARK JOBS RUNNING ON DISTRIBUTED COMPUTING CLUSTERS filed Apr. 26, 2024 which is incorporated herein by reference for all purposes.

### BACKGROUND OF THE INVENTION

One of the challenges of cloud computing is tackling the hundreds of different hardware configurations and settings a user can select when running their jobs. The consequences of a poor selection can lead to long run times and significant cloud computing costs. Both longer run times and larger costs are significant issues for users of a cloud infrastructure. A user could test run a job on all possible different instances of the cloud infrastructure using all possible combinations of settings and select the configuration which provides the lowest cost and runtime. This manual operation would be impractical as running the tests would generally cost more than running the actual job with sub-optimal settings. Such a technique may also require a significant amount of time to complete the tests. Moreover, the compute needs of a recurrent job can depend on factors such as the time of the day, frequency with which the job is run (e.g. hourly, daily, weekly, monthly, or quarterly), or other factors. Such dependencies may make it infeasible if not impossible to “right-size” a compute cluster on an ongoing, real-time basis with any kind of manual process. Accordingly, an improved mechanism for selecting or updating cloud resources for jobs executed on the cloud infrastructure are desired.

### BRIEF DESCRIPTION OF THE DRAWINGS

Various embodiments of the invention are disclosed in the following detailed description and the accompanying drawings.

FIGS. 1A and 1B depict an embodiment of a computing system architecture for optimizing configurations of cloud resources for one or more job(s) and an embodiment of the optimizer that may be used.

FIG. 2 is a flow-chart depicting an embodiment of a method for automatically provisioning resources.

FIG. 3 depicts a system for optimizing cluster size for a job using a fixed instance type.

FIG. 4 is a diagram illustrating mapping information to an intermediate fundamentals domain and an optimization domain.

FIGS. 5A-5B depict a flow diagram illustrating an embodiment of a process for optimizing in an intermediate fundamentals domain.

FIGS. 6A-6B depict a flow diagram illustrating an embodiment of a process for optimizing in an intermediate fundamentals domain.

FIGS. 7A-7C depict graphs showing cloud resource allocation over multiple runs.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A large majority of big data and machine learning jobs today are run on distributed computing clusters (e.g. sets of cloud computing cores, or nodes) hosted by cloud providers. However, setting up these clusters with the right kind of hardware configuration specific to the needs and requirements of a machine learning query or other big data workload presents customers of cloud providers with a massive combinatorial problem. There are a very large number of choices and decisions to make when attempting to optimize computing jobs for cost, run duration and other metrics of value. The consequences of a poor selection can lead to long run times and significant cloud computing costs. A user could manually test their job on all possible instances of the cloud infrastructure using all possible combinations of settings. The user may then select the configuration which provides the lowest cost and/or run time. However, this technique for allocating resources is highly inefficient. Users may thus be tempted to make large changes to cloud infrastructure in order to test their options more quickly. However, not only does this increase the likelihood of overlooking an improved configuration, making large changes to the cloud infrastructure increases the potential for errors or other issues that prevent the job from running appropriately. Moreover, the compute needs of a recurrent job can depend on the time of the day and/or other temporal factors, making it infeasible if not impossible to determine an optimal configuration for a compute cluster on an ongoing, real-time basis with any kind of manual process. As a result, most users simply choose the characteristics of the cloud infrastructure they believe may be appropriate and accept the consequences in run time and/or cost. Thus, processing in the cloud infrastructure may inefficiently utilize cloud resources, require larger times to complete a workload, consume more power than necessary, and result in the user incurring significant unnecessary financial costs. Consequently, techniques for improving the allocation of resources in computing systems such as cloud computing systems are desired.

A method for optimizing a workflow provided to a cloud computing system is described. The method includes extracting information from at least one log file for a job. The log file(s) are for at least one run of the job (e.g., correspond to a run of the job). The information extracted may include task data, cloud settings, hardware information, cloud economic information and/or cloud reliability information. The information may be extracted from cluster log files and/or event log files (e.g. from APACHE SPARK or other analytics engine). The method also includes determining a recommended allocation of cloud resources for the job based on the information from the log file(s). For example, the recommended allocation of the cloud resources may include determination of a number of workers in a cluster, the worker instance type, the instance size and/or other aspects of the cloud resources allocated to the job. The recommended allocation of the cloud resources includes an incremental change from a most recent allocation of cloud resources. For example, a change in cluster size of one worker, five percent, or ten percent from the most recent allocation of cloud resources may be included in the recommended allocation. In some embodiments, a sequence of recommendations may be generated. In such an embodiment each recommendation in the sequence may include an incremental change from an immediately previous recommendation in the sequence. In some such embodiments, the sequence of recommendations may be automatically implemented for the cloud resources. Thus, a user may opt to (or opt not to) implement a recommended allocation or the recommended allocation may be automatically implemented. Similarly, a system for provisioning cloud resources is described. The system includes processor(s) and memory. The memory is coupled to the processor and configured to provide the processor with instructions. The processor(s) are configured to extract information from log file(s) for the job and determine a recommended allocation of cloud resources for the job based on the information from the log file(s). The recommended allocation includes an incremental change from a most recent allocation of cloud resources. A computer program product embodied in a non-transitory computer readable medium is also described. The computer program product includes computer instructions for extracting information from log file(s) for the job and determining a recommended allocation of cloud resources for the job based on the information from the log file(s). The recommended allocation includes an incremental change from a most recent allocation of cloud resources.

In some embodiments, the techniques described provide an automated loop that optimizes cloud resource allocation, for example optimizing the cluster size and worker instance of cloud-based distributed computing clusters. The technique iteratively generates updated recommendations for cluster configurations upon completion of a job run that implements a previous recommendation. The updated recommendations may be generated by models that attempt to continuously move toward optimal configurations while also adapting to changing job conditions.

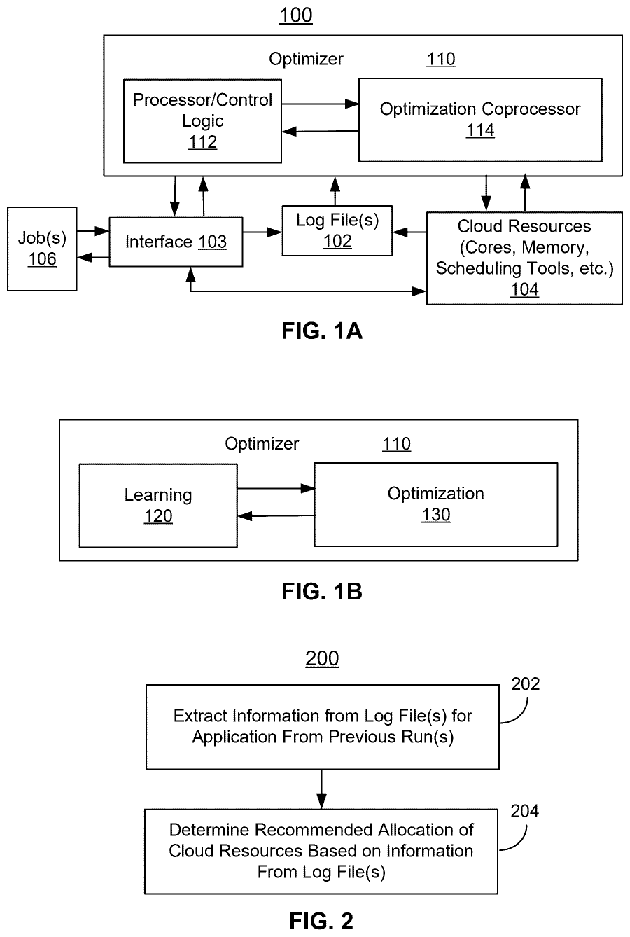

FIGS. 1A and 1B depict an embodiment of computing system architecture 100 for optimizing configurations of cloud resources 104 for one or more job(s) 106 and an embodiment of an optimizer. For clarity, not all components are shown. In some embodiments, different and/or additional components may be present. In some embodiments, some components might be omitted. System 100 includes optimizer 110, interface 103, and cloud resources 104. Also shown are jobs 106 desired to be run using configurations of cloud resources 104. In some embodiments, the job(s) 106 may be run with or without optimizer 110 attempting to allocate resources. For example, job(s) 106 may be run utilizing default or user-selected settings.

Interface 103 is used to access cloud resources 104 for job(s) 106. Interface 103 may be APACHE SPARK or other engine used to run job(s) 106 on cloud resources 104. For example, interface 103 may be used to generate SQL queries (or analogous task(s)) for job(s) 106 and schedule periodic runs of the queries on cloud resources 104. In some embodiments, interface 103 communicates directly with cloud resources 104 in order to execute job(s) 106. In some embodiments, interface 103 accesses cloud resources 104 via optimizer 110. In some embodiments, information related to job(s) 106 is provided to interface 103. For example, information about the input data size, schema, file type, skew, code, ecosystem, platform, or user submitted information may be provided. Optimizer 110 may also use this information in optimizing the allocation of cloud resources 104 for job(s) 106.

Log file(s) 102 contain information relating to performance of cloud resources 104 in completing job(s) 106. Log file(s) 102 may be generated when the job(s) 106 are run on cloud resources 104. Log file(s) 102 may be generated by interface 103 and/or cloud resources 104. For example, log file(s) may include APACHE SPARK log files (i.e. generated by interface 103) and/or cluster log file(s) (generated by cloud resources 104). Although described in the context of log files, metadata (including but not limited to data such as cluster and SPARK log files) may be used in some embodiments.

Cloud resources 104 may include one or more servers (or other computing systems) each of which includes multiple cores, memory resources, disk resources, networking resources, schedulers, and/or other computing components used in implementing tasks for executing job(s) 106. In some embodiments, for example, cloud resources 104 may include a single server (or other computing system) having multiple cores and associated memory and disk resources.

Optimizer 110 includes processor(s) and/or control logic 112 and optimization coprocessor(s) (OC) 114. In some embodiments, optimizer 110 may also include memory (not shown). Processor 112 may simply be control logic, an FPGA, a CPU and/or a GPU used in controlling OC 114. In some embodiments, processor(s) 112 might be omitted. OC(s) 114 may be used to model behavior of job(s) 103 for various configurations of cloud resources 104 and to provide recommended allocations of clod resources 104. Similarly, although a single OC 114 is shown, in some embodiments, optimizer 110 may include multiple OCs 114.

Optimizer 110 may also be viewed in terms of its functionality. FIG. 1B depicts optimizer 110 as including learning phase 120 and an optimization phase 130. Learning phase 120 and optimization phase 130 may be performed using OC(s) 114 and may be considered to form a closed-loop control over cloud resource allocation. In learning phase 120, optimizer 110 may receive and extract information from log file(s) 102, provide (previously generated) recommended allocations for job(s) 106, and may implement the recommended allocations for the next run of job(s) 106. In some embodiments, a sequence of recommended allocations is generated. In such embodiments, learning phase 120 may continue operation until the sequence of recommended allocations is exhausted, until a user inputs an allocation of cloud resources that differs from a previously recommend and/or used allocation, or until another condition is fulfilled.

Optimization phase 130 may be employed when no previously generated recommended allocations (if any) are available for use, if a user has updated the resource allocation, and/or if another condition is fulfilled. In optimization phase 130, a model of the performance of allocated cloud resources 104 for a job 106 is updated using information from learning phase 120 and recommended allocation(s) of cloud resources are generated. For example, information extracted from log files 102 in learning phase 120 may be used to update the model. Based on the performance indicated by log files 102 (e.g. using the model incorporating information from log file(s) 102), one or more recommended allocations of cloud resources are determined in optimization phase 130. Optimization phase 130 may also constrain the recommended allocations to be incremental in nature. Such recommended allocations are thus based upon the previous (e.g. the most recently used) allocation of cloud resources. For example, the recommended allocation may be to increment or decrement currently allocated resource(s) by not more than ten percent (e.g. from a cluster size of ten to a cluster size of eleven), by not more than five percent, and/or by not more than a single unit (e.g. from a cluster size of two to a cluster size of three). Optimizer 110 may then return to learning phase 120 as the recommended allocation(s) are provided to a user for implementation (or automatically implemented) and additional data relating to performance of job(s) 106 obtained.

Thus, based on the information in the log file(s) 102, optimizer 110 generates recommended allocations of cloud resources 104 of the job. Thus, performance of system 100 and use of cloud resources 104 may be enhanced. Because the changes to the cloud resources 104 allocated are incremental in nature, a customer's infrastructure may be protected from wide swings in configuration. Thus, performance of system 100 and use of cloud resources 104 may be enhanced.

FIG. 2 is a flow-chart depicting an embodiment of a method for automatically provisioning resources. Method 200 may be used in conjunction with system 100. However, in other embodiments, method 200 may be utilized with other systems. Although certain processes are shown in a particular order for method 200, other processes and/or other orders may be utilized in other embodiments. Method 200 is also described in the context of allocating resources for a single job. In some embodiments, resources for multiple jobs may be allocated. In such embodiments, interactions between jobs that are to be processed at overlapping times may be considered by method 200.

Method 200 starts after one or more log files for a job have already been generated. Thus, method 200 starts after the job has been run at least once. During processing for a job, a log file is typically generated by the cloud resources and/or the interface used. In general, one log file is generated for each time a job is processed. Cloud resources for a particular run of the job resulting in a log file may have been allocated using built-in schedulers, user selections related to cloud resources (e.g. the number of cores used), and/or other techniques. Thus, processing for the job may have been completed using settings for the cloud resources that are sub-optimal. Consequently, the log file used need not include optimal resource allocation.

Information is extracted from the log file(s) for the job, at 202. In some embodiments, the information extracted may include task data and cloud settings. Task data relates to what the individual tasks for the job are and the amount of data used for the job. The cloud settings relate to characteristics of the cloud service for which cloud resources are desired to be allocated. Some of these settings may be selected by the user. For example, cloud settings may include the number of cores used, data partitions, the memory for each core, and/or other settings (e.g. SPARK™ settings). Hardware information, cloud economic information and/or cloud reliability information may also be obtained at 202. Hardware information may be extracted from the log file and/or obtained other sources such as the user and/or public sites detailing the hardware configurations available for a particular cloud service. Hardware information may include the type and number of processing units, the type and size of memory, the network bandwidth and the disk bandwidth. Cloud economic information and/or cloud reliability information may be extracted from the log file and/or acquired from other sources (e.g. the user and/or public sites). Cloud economic information may also include pricing information. Such pricing information may include fixed prices (on-demand) or variable prices (spot instances), which vary daily and across geographical regions.

The recommended allocation of cloud resources for the job is determined based on the information from the log file(s), at 204. For example, the allocation of the cloud resources may include the number of workers (e.g. a number of cores) in a cluster allocated to the job, the worker instance, and/or other aspects of the infrastructure to be allocated. In some embodiments, a predicted cost for each of the recommended allocation is also determined and used to identify the recommended allocation at 204.

For example, optimizer 110 may extract information from log file(s) 102 for job(s) 106, at 202. Thus, 202 may be part of learning phase 120. In some embodiments, optimizer 110 analyzes log file(s) 102 and extracts the data desired for the particular configurations. Optimizer 110 may also use cloud cost information, cloud reliability information and/or other relevant information. In some embodiments, optimizer 110 may obtain some of this information (e.g. cloud cost and/or reliability information) from other sources. Based on the information extracted, optimizer 110 generates one or more recommended allocations of the cloud resources, at 204. Thus, 204 may be part of optimization phase 130. Optimizer 110 may also determine the predicted cost and/or consistency with the service level agreement for the various hardware infrastructures and base recommended allocations on the cost and ability to meet the service level agreement. Optimizer 110 may also constrain the recommendations (e.g. by constraining a search region) to incremental changes from the most recently used configuration. For example, a first recommended allocation may be to increment the number of workers for a most recently used allocation by one, a second recommended allocation in a sequence may be to increment the number of workers of the most recently used allocation by two. In some embodiments, optimizer 110 implements any changes to the resources allocated to job 106 as part of 204.

Thus, resources may be allocated for the job. Whether this is performed automatically or by the user taking into account information provided by method 200, the allocation of resources may be improved. As a result, execution of the job may be more efficient. For example, run time and/or costs may be reduced. Power consumption may also be reduced (e.g. due to the reduction in run time). Further, the process of allocating resources may be made more error resistant. Incremental changes from previous recommendations limit unforeseen issues that may arise from a new configuration. In some embodiments, errors are automatically accounted for and resolved by optimizer 110. In some embodiments, method 200 may account for periodicity in the job (e.g., daily fluctuations in data size, cloud resource performance, etc.). Thus, the resources allocated for a job may be optimized dynamically as job demands change. Consequently, performance and efficiency may be improved.

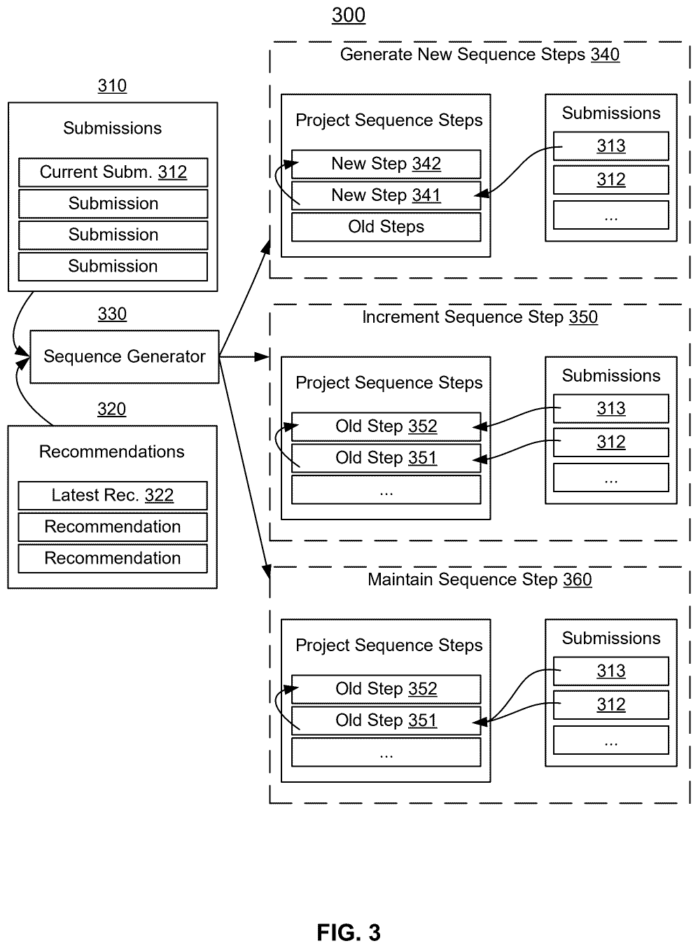

In some embodiments, method 200 and optimizer 110 are used to generate recommendations for optimizing allocation of particular computing resources. For example, method 200 may be used to optimize cluster size (e.g. number of workers for a particular instance size), to optimize worker instance (e.g. in addition to the number of workers for that instance), to optimize the cluster based on the number of worker and instance size, and/or to account for cyclical characteristics of the job (e.g. cyclical variations in the size of the data set). Embodiments of such optimizations performed using method 200 and optimizer 110 are described in the context of FIGS. 3, 4, 5A-5B, 6A-6B, and 7.

FIG. 3 depicts system 300 for optimizing cluster size for a job using a fixed instance type. Thus, system 300 may be used in performing one embodiment of method 200. In system 300 a submission is information from a particular run of a job that used a particular configuration (or allocation) of cloud resources. For example, a submission may be generated by learning phase 120. A recommendation includes a recommended allocation of resource (e.g. provided via optimizer 130) for a run of the job. A recommendation may be generated by optimizer 130. A sequence is a series of recommendations (a series of recommended allocations of resources) usable in runs of the job. A sequence step is one entry in the series and includes a recommendation. Adjacent sequence steps differ incrementally. For example, a current sequence step (or recommendation 322) may have a number of workers that differs from that of next previous sequence step (or recommendation 321) by ten percent, five percent, or unit change (e.g. one worker).

In system 300, submissions 310 and recommendations 320 are used by sequence generator 330 in three ways: generate new sequence steps 340, increment sequence step 350, or maintain sequence step 360. In various embodiments, submissions of submissions 310 include raw data (e.g., cluster log files, event logs of the job etc.), job-related metadata (e.g., data size, schema, file type, or user submitted information), and/or any other appropriate information used in generating recommendations. Thus, submissions 310 include data obtained from run(s) of the job made with various cloud resources allocations. The raw data in submissions may be converted into information that can be more easily processed (e.g., by sequence generator 330).

The data of the submission may be converted for use in resource allocation. In some embodiments, various tasks perform portions of the data conversion. In one example, a first task copies raw data of the submission from its original environment into a managed environment. Event log data, for example, is split and chunked by a second task. The second task also extracts desired information and metrics such as memory consumption, garbage collection statistics, and the cloud region that the job ran on. The second task may also perform the computations used to accurately determine run time and detailed cost breakdown and to monitor progress towards runtime and cost goals. The second task also prepares the metrics for subsequent tasks. Subsequent tasks compute metrics such as the number of jobs completed successfully, the frequency with which run time service level agreements (SLAs) were met, the true cost and run duration of a job run, and garbage collection and memory usage statistics. In some embodiments, the completion of these functions may be organized in another manner (e.g. completed by a single task).

Each submission for a job, excluding the first, may be associated with an existing recommendation 320 (e.g., via a sequence step). In such cases, the cluster configuration of an incoming submission (data from a current run of the job) has been determined by a recommendation generated at the end of the previous submission (data from a previous run of the job). However, a user may choose not to apply the recommendation, potential failures in the customer's job or in the submission process may interfere, or the submission may be the first submission. Consequently, there are cases where the current submission differs from the existing recommendation.

If current submission 312 is the first submission, then sequence generator 330 initiates generation of new sequence steps 340. Next submission 313 is then linked with the first new sequence step 341. If current submission 312 is not the first submission, sequence generator 330 determines whether current submission 312 has the same cluster configuration and parameters as latest recommendation 322. If it does not, latest recommendation 322 was not applied for current submission 312 (e.g., the user opted not to implement latest recommendation 322). Thus, sequence generator 330 initiates maintain sequence step 360. Next submission 313 is then linked with old sequence step 351 (still associated with latest recommendation 322). Thus, the new recommendation is the same as latest recommendation 322. In some embodiments, maintain sequence step 360 may be initiated only if current submission 312 used an identical configuration to a previous submission (e.g., a user ignored recommendation 322 entirely). In such embodiments, it is determined whether the configuration was deliberately modified in a way that does not conform to recommendation 322 (e.g., the user deliberately changed aspects of the configuration). In response to determining that the configuration was deliberately modified, the deliberate modifications to the configuration may be incorporated into future recommendations of recommendations 320.

If current submission 312 was generated by application of latest recommendation 322 (e.g., by a run of the job using the recommended cloud resources), sequence generator 330 determines whether a new recommendation is available in recommendations 320 (in the example shown there is not a new recommendation available). In response to there being a new recommendation available, sequence generator 330 initiates increment sequence step 350 and assigns the new recommendation to next submission 313 (shown as old step 352, immediately following old step 351 associated with current submission 312). Thus, the next sequence step used in generating a submission includes the cloud resource allocation of the new recommendation. In response to there not being a new recommendation available, a new recommendation is generated. In various embodiments, the specifics of the new recommendation are determined based on sequence generator 330 requiring additional learning sequences, a user request affecting the configuration (e.g., the user deliberately changing aspects of the configuration as described above), and/or an indication to switch to an optimizing phase (e.g., analogous to optimization 130 in FIG. 1B).

System 300 starts in a learning phase (e.g., analogous to learning phase 120 in FIG. 1B), in which the first recommendation is generated. The first recommendation may attempt to optimize a particular setting(s) and leave other aspects of the cluster configuration constant. A long with generating the first recommendation, additional recommendations are generated with distinct cluster configurations and these are enqueued. Each of these recommendations differs only in the number of workers recommended, while all other cluster configuration parameters remain the same. At the end of this process, the recommendation queue is populated with new recommendations in the learning phase. In various embodiments, the learning phase comprises three recommendations, six recommendations, or any other appropriate number of recommendations.

Project sequence steps, common across the usage of sequence generator 330, keep track of which recommendations have been applied by which submissions. Arrows shown in FIG. 3 (e.g., in generate new sequence steps 340) point from submissions to sequence steps associated with a particular recommendation, which in turn point to subsequent sequence steps associated with enqueued future recommendations.

As each submission is processed by system 300, if the incoming submission applied the recommendation pointed to by the current sequence step, the current sequence step of the project is updated to point to the next item in the recommendation sequence. This process continues until all the points added to the recommendation sequence in the learning phase have been implemented and submissions received. Upon processing the queue generated in the learning phase, system 300 enters the optimizing phase (e.g. optimizing phase 130). In this phase, the runtime and cluster configuration information of all the submissions of the learning phase are pooled and a predictive model is fit to this data. In some embodiments, the model takes the form

Runtime=S+P+C
where S represents the contribution to the run time by all serial computation processes, P represents the contribution to the total run time by all parallel computation processes, and C is the contribution arising from inter-worker communication. Although a three-parameter model is shown, in various embodiments another model(s) may be used. The individual contributions of each of the terms in the model are learned by fitting the model to the runtime data contained in existing submissions. The predictions of the run time model are then paired with detailed cost calculations and estimates of the cost of the job under different scenarios of number of workers are determined (e.g., using another predictive model). In some embodiments, a configuration with lowest estimated cost is then used to generate the next recommended cluster configuration (i.e., the next recommendation). In some embodiments, other criteria are used. For example, recommended cluster configurations may prioritize meeting a user's service level agreement (SLA) and configurations determined not to meet the SLA may be omitted when identifying the configuration with lowest estimated cost.

In some embodiments, each new successful incoming submission, including during the optimizing phase, contributes to updating parameters of the runtime model. In other words, information from runs of the job (e.g., each run) may be used to update the model. Thus, system 300 may be considered to enter the learning phase as recommendations are applied automatically or by a user (i.e. cloud resources allocated to match the recommended allocations) and the job run with the corresponding configurations. System 300 may also be considered to the learning phase if a user opts not to apply the recommendation (i.e., the same configuration of cloud resources is reused) or the user manually changes the configuration of cloud resources for a job run. The submissions are then processed and used in the optimization phase to update the model and generate new recommendations. This gives system 300 the ability to adapt automatically in response to variations in workload. Thus efficiency of cloud resource allocation may be improved. At the end of each submission, the search domain of possible configurations may be enlarged by some amount, and runtime predictions are made for all configurations that meet the constraints of that search domain. The recommendation generated may be the lowest cost outcome of the combination of the runtime model and cost model. Thus cost of cloud resource allocation may be reduced. System 300 may, therefore, dynamically update the recommended allocations of cloud resources for jobs run. Consequently, performance of cloud resources in completing the job may be improved and costs reduced.

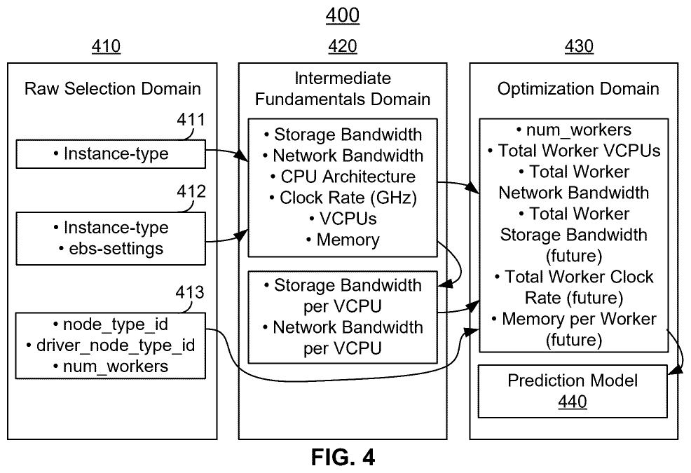

FIG. 4 is a diagram illustrating mapping information to an intermediate fundamentals domain and an optimization domain. This mapping may be used in generating new recommendations, for example for optimizing worker instances. Raw selection domain 410 includes cloud resource parameters 411, cloud resource parameters 412, and cloud resource parameters 413. In some embodiments, cloud resource parameters 411, cloud resource parameters 412, and cloud resource parameters 413 control the configuration of distinct cloud resources (e.g., resources associated with different cloud providers). In such embodiments, cloud resource parameters 411, cloud resource parameters 412, and cloud resource parameters 413 may be specific to the distinct cloud resource(s) they are associated with. For example, “instance-type” of cloud resource parameters 411 may function differently to “instance-type” of cloud resource parameters 412, and may not have an equivalent in cloud resource parameters 413. As a result, optimization using information in raw selection domain 410 may be challenging.

Regardless of specific nomenclature, an instance is typically associated with fundamental compute properties listed in intermediate fundamentals domain 420. These quantities may be expected to influence the performance of a job in a manner that can be evaluated and predicted. Thus the choice of instance in raw selection domain 410 is mapped to an analogous choice of quantities in intermediate fundamentals domain 420. Thus, cloud resource parameters 411 and cloud resource parameters 412 are mapped to various fundamental properties (e.g. particular storage bandwidth and network bandwidth). When many instances with these fundamental properties are put together, they yield the cluster-level quantities listed in optimization domain 430. Thus, the parameters in intermediate fundamentals domain 420 may be mapped to optimization domain 430. Quantities in intermediate fundamentals domain 420 may be normalized (e.g., per V CPU, as shown in diagram 400) before being mapped to optimization domain 430. Optimization domain 430 may also incorporate cloud resource parameters that affect the entire cluster (e.g., cloud resource parameters 413) rather than an instance. Such cloud resource parameters may be mapped directly to optimization domain (e.g. cloud resource parameters 413 are mapped to optimization domain 430). Consequently, cloud resource parameters 411, 412, and 413 for distinct instances in raw selection domain 410 may be mapped to optimization domain 430. Optimization domain 430 may be evaluated by prediction model 440 to determine an optimized configuration of cloud resources (using any appropriate optimization strategy/strategies, e.g., cost, run time, SLA evaluation, etc.).

The mapping of diagram 400 may limit the complexity of choosing instance types by identifying fundamental properties of an instance that contribute to an optimized configuration. Rather than considering instance types as discrete units with inconvertible parameters, properties in intermediate fundamentals domain 420 and optimization domain 430 may be evaluated as continuous dimensions along which instance types may exist. In some embodiments, a property in intermediate fundamentals domain 420 and optimization domain 430 may not be evaluable as a continuous dimension (e.g., choosing CPU architectures from only two manufacturers). In various such embodiments, the property is evaluated through direct comparison (e.g., A-B testing of a number of configurations involving both choices) or any other appropriate method. For example, A-B testing may include running jobs with configuration A, running the job with cloud resource configuration B, and comparing the results.

E valuation may be made more efficient through instance type equivalence. By defining a set of constraints on the degrees to which instance types may vary in intermediate fundamentals domain 420, a set of equivalent instances (i.e., instances sharing similar fundamental compute properties) may be found.

In an example, a set of constraints used to determine instance equivalence dictates that memory of the instance not vary from a reference instance by more than 1.5 GB, and additional modifiers such as processor architecture are identical to the reference instance. This narrows a set of forty-two possible instances down to a set of three equivalent instances. While searching for optimized configurations over forty-two different instance types may be infeasible, the set of constraints and resulting set of equivalent instances allows for evaluation to meaningfully converge on an optimal instance type.

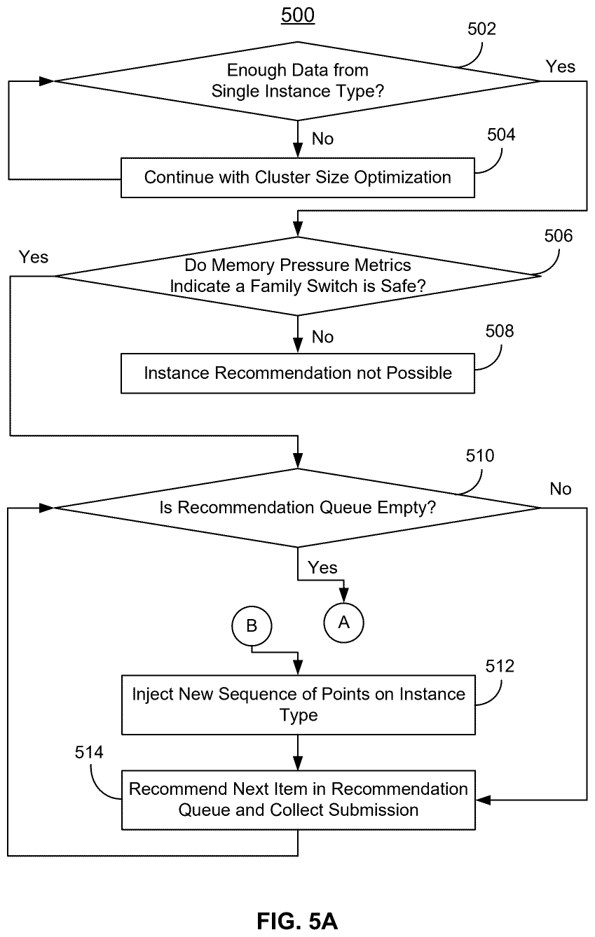

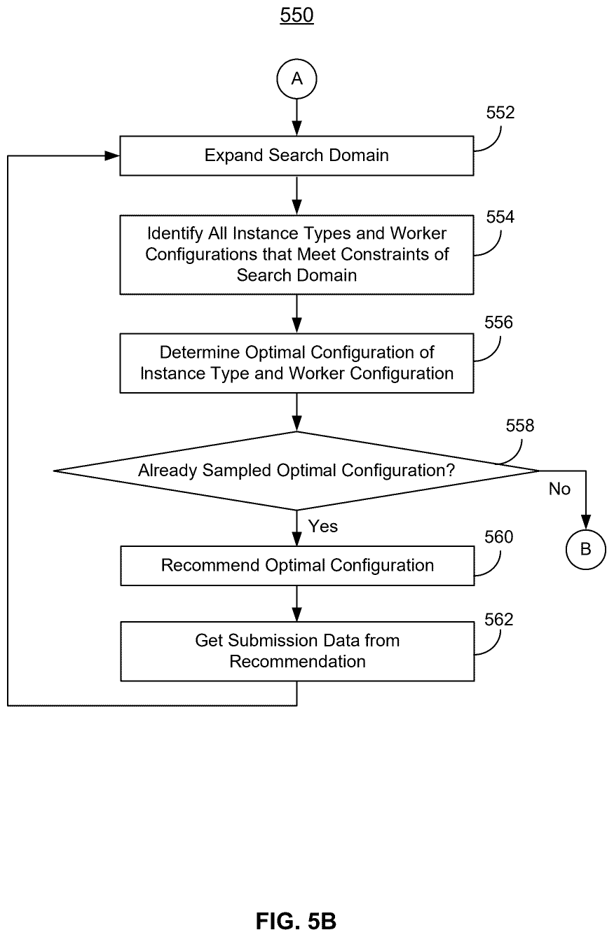

FIGS. 5A-5B depict a flow diagram illustrating an embodiment of a process for optimizing in an intermediate fundamentals domain (e.g., intermediate fundamentals domain 420 of FIG. 4). FIGS. 5A and 5b may thus be viewed as a technique that may be used in optimizing the worker instance. FIG. 5A depicts the process for learning phase 500, while FIG. 5B depicts the process for optimizing phase 550. In 502, it is determined whether there is a sufficient amount of data on an initial worker instance type for an optimization phase to be completed. In some embodiments, at least five datapoints (e.g., five different cluster sizes) are used. Another number of datapoints may be used in other embodiments. In response to there not being enough data (e.g. fewer than five datapoints-data for fewer than five different cluster sizes), control passes to 504 and cluster size optimization continues until there are enough datapoints. In some embodiments, cluster size optimization in 504 is performed in a manner analogous to FIG. 3. If there is a sufficient amount of data, then control passes to 506.

In 506, it is determined whether metrics, such as memory pressure metrics, indicate that a family switch is safe (i.e., that worker instance optimization is possible). Memory pressure metrics indicate whether the cloud memory resources are under sufficient strain that performance may suffer (e.g., slower performance or instability). An instance family has sufficiently similar characteristics (e.g., CPUs and memory) that an instance may be optimized for configurations in the family. It is thus determined in 506 whether the instance family may be changed without significantly adversely affecting performance (and thus worker instance optimized). 506 may include calculating the memory pressure metrics and/or other metrics and comparing them to predetermined thresholds. In various embodiments, the predetermined thresholds are based on available cloud resources (e.g., memory capacity of available instance types), job metrics (e.g., estimated memory usage of the job), and/or any other appropriate information. Such thresholds may be updateable. In some embodiments, other metrics may be used in addition to or in lieu of memory pressure metrics to indicate whether a family switch is safe. In response to an indication that a family switch is safe, worker instance optimization is considered to be possible, and control passes to 510. In response to an indication that a family switch is unsafe, control passes to 508, in which instance recommendations are considered not to be possible and the process may terminate.

In 510, it is determined whether optimization phase 550 may be entered. For example, in some embodiments, 510 determines whether the current recommendation queue is empty. In response to the recommendation queue not being empty (i.e., learning phase 500 continues), control passes to 514. In 514, the next item in the recommendation queue is recommended and a submission is collected (i.e., the learning phase continues and additional data for the allocated resources, for example in the form of log files, is collected). 514 may be performed in a manner analogous to FIG. 3 (i.e., based on the submission and/or actions of a user, recommendations may not be dequeued, new recommendations may be enqueued, etc.). In response to the recommendation queue being empty, optimizing phase 550 is entered and control passes to 552.

In 522, the search domain for the optimization is expanded. In some embodiments, the search domain is expanded by a fixed amount per iteration. For example, the search domain may be expanded by a particular percentage (e.g., ten percent) or by a particular amount (e.g. one additional worker) for certain aspects of the configuration. Alternatively, a dynamically varying expansion strategy may be employed (e.g., a strategy to balance tradeoffs between exploration and exploitation).

In 554, constraints are applied to the search domain. Also in 554 instance types and worker configurations meeting the constraints are identified. The constraints may narrow the list of instances to identify according to an optimization strategy. Thus search efficiency and effectiveness of configuration recommendations may be improved. Examples of these constraints include searching for instances at constant memory, instances that both have constant memory as well as the same instance modifiers, or instances that have the above two constraints as well as fixed generation, etc. The optimization strategy is determined by a combination of factors, including metrics associated with the job, an estimation of memory pressure, and/or any other appropriate information. In some embodiments, the constraints are within the intermediate fundamentals domain.

In 556, an optimized configuration of instance type and worker configuration is determined. In some embodiments, runtime and cost are predicted for each instance identified in 554 and the optimized configuration is identified based on the predictions. The predictions are derived from at least one predictive model. In some embodiments, the predictive model(s) include a multi-parameter model (e.g., a four-parameter model, a ten-parameter model, or any other appropriate model). Parameters may capture distinct aspects of the fundamental computational properties associated with a configuration.

In 558, it is determined whether the optimized configuration of instance type and worker configuration has already been sampled (e.g., in learning phase 500) and whether sufficient data has been collected for it. In response to the configuration not being sufficiently sampled, learning phase 500 is re-entered and control passes to 512. In 512, a new sequence of points is injected on the instance type associated with the optimized configuration, and completion of the sequence occurs in learning phase 500 before re-entering optimizing phase 550. In various embodiments, the new sequence consists of 3 points, 4 points, 5 points, 10 points, or any other appropriate number of points. In contrast to cluster size optimization, in which a learning phase is never re-entered, the process of FIGS. 5A-5B may alternate between learning phase 500 and optimizing phase 550.

In response to the optimized configuration being determined to be sufficiently sampled in 558, control passes to 560. In 560, the optimized configuration is provided as a recommended allocation. In 562, the recommended allocation may be implemented and submission data from the recommendation allocation gathered.

In some embodiments, in response to determining there is sufficient data for the instance, the original optimal configuration identified via predictive model(s) is discarded and an optimum is recalculated. In some such embodiments, the optimum is recalculated by using individual models (e.g., three-parameter models) on each of a set of available instance sizes. The recalculating may improve accuracy of predictions and of recommendations of optima.

At least a portion of the process of FIGS. 5A-5B may be repeated for each run of the job. For example, control may pass to 510 for submissions after the first run of the job. Subsequent runs may thus generate recommended allocation (s for each run. Thus, the configuration of the cloud resources may be iteratively updated. Performance of a system utilizing the recommended cloud resources may thus be improved.

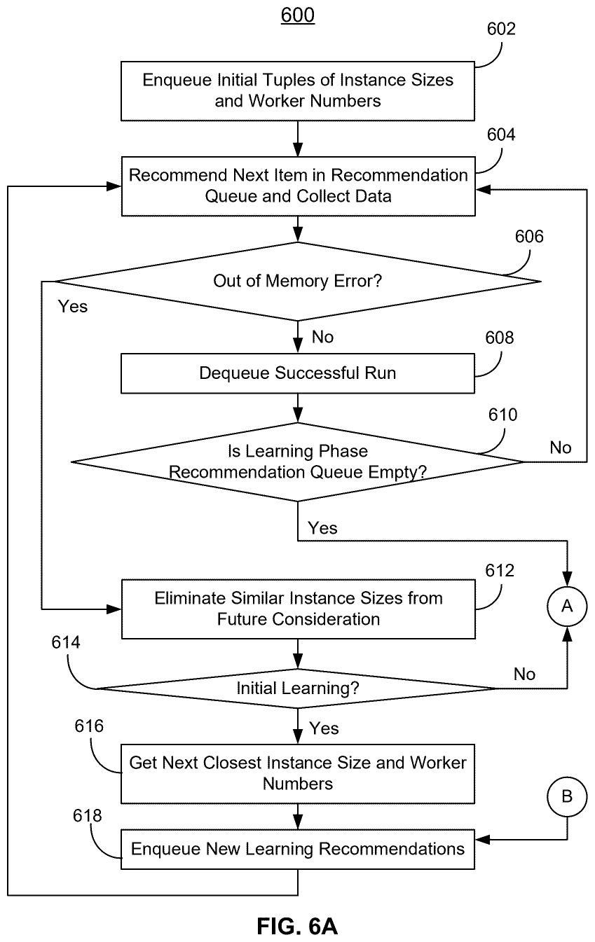

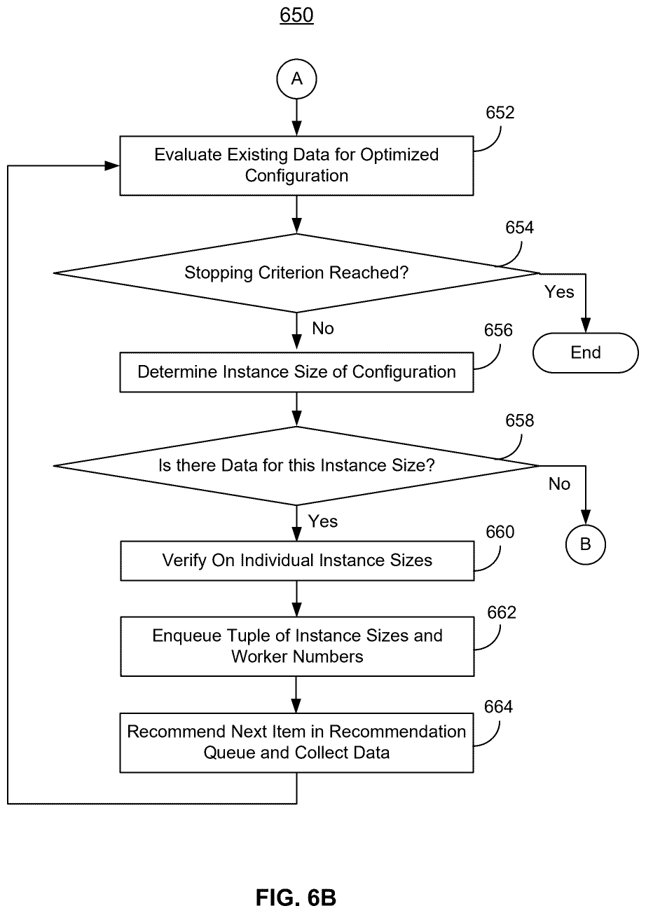

FIGS. 6A-6B depict a flow diagram illustrating an embodiment of a process for optimizing using an intermediate fundamentals domain (e.g., intermediate fundamentals domain 420 of FIG. 4). FIGS. 6A and 6B may thus be viewed as a technique that may be used in optimizing cloud resource allocation for a job by optimizing number of workers and in instance size. FIG. 6A depicts the process for learning phase 600, while FIG. 6B depicts the process for optimizing phase 650.

To generate a recommended allocation including an incremental change in instance size, two adjacent instance sizes are determined with respect to the current instance size the job is running on with proper boundary handling. While calculating the adjacent instance sizes, instance type may remain fixed. Appropriate numbers of workers for each of the adjacent instance sizes are determined and tuples of instance sizes and worker numbers are enqueued as a sequence of recommendations, in 602. In some embodiments, six tuples are enqueued (e.g., three tuples for each adjacent instance). In 604, the next item from the recommendation queue is recommended, the job is run with the recommended allocation, and submission data is collected (e.g., in the manner described in FIG. 3). Thus, the additional data for the allocated resources, for example in the form of log files, is collected and information in the log files extracted to provide the submission. In 606, it is determined whether an incoming submission failed due to an Out of Memory error.

In response to the incoming submission failing due to such an error, control passes to 612. In 612, the instance size of the failed submission and all smaller instance sizes are eliminated from future consideration. Thus, the process of FIGS. 6A-6B may reduce future errors by modifying the allocation of cloud resources for the job. Instead, after determining that initial learning is still occurring in 614 (i.e., optimizing phase 650 has not yet been entered), the next closest instance size and worker numbers are determined in 616, and new learning recommendations are enqueued into the recommendation queue in 618. Learning phase 600 then returns to 604 for an additional run of the job using the new recommended allocation (i.e., another tuple of instance size and worker number).

In response to the incoming submission succeeding, the successful run is dequeued in 608. In 610, it is determined whether the learning phase recommendation queue is empty. In response to the queue not being empty, control passes to 604. In response to the queue being empty, optimizing phase 650 is entered. Similarly, in response to determining that initial learning is not still occurring in 614, control passes to 652 within optimizing phase 650.

In 652 of optimizing phase 650, existing data is evaluated for an optimized configuration of resources. In some embodiments, the existing data is evaluated using at least one model containing terms to predict run time for different cluster configurations. In the embodiment shown, the model for run time may be:

Runtime=S+P+C+N

The term denoted by S represents the contribution to the runtime by all serial computation processes. The term denoted by P represents the contribution to the total runtime by all parallel computation processes. The term denoted by C is the contribution arising from inter-worker communication. Thus the model for run time may be similar to the three-parameter model for cluster size optimization described in the context of FIG. 3. The additional term denoted by N captures any contributions to the total run time arising from the total network bandwidth in the cluster. Although a four-parameter model is shown, the model(s) may include a three-parameter model, a ten-parameter model, or any other appropriate model(s). For example, the four-parameter run time model shown above may be paired with a predicted cost model (e.g., corresponding to a five parameter model). In some embodiments, 652 includes applying the model to all the submissions across all instance sizes for which there is data. The optimized configuration of 652 could be from any instance size from the same instance type as the submissions of the learning phase. In 654, it is determined whether stopping criteria have been reached. For example, the most recently recommended configuration may be identical to the optimized configuration. In such a case, the stopping criteria may be reached. Other stopping criteria may be used in other embodiments. In response to the stopping criteria being reached, the process of FIGS. 6A-6B terminates. In response to the stopping criteria not being reached, control passes to 656. In 656, the instance size of the optimized configuration is determined. In 658, it is determined whether there is data associated with the instance size of the optimized configuration.

In response to there not being data associated with the instance size, control passes to 618 and learning phase 600 is reentered. In learning phase 618, a new sequence of recommendations is enqueued including the instance size of the optimized configuration. In various embodiments, the sequence includes three recommendations (e.g., three instance size/worker number tuples), six recommendations, or any other appropriate number of recommendations. The numbers of workers enqueued within the sequence may be calculated in such a way as to constrain the growth of the cluster. Cluster size (e.g., the total vCPUs) and the number of workers may thus be reduced.

In response to there being data associated with the instance size, control passes to 660. In 660, the optimized configuration is verified using individual instance sizes. In some embodiments, the model(s) of 652 (e.g., the four-parameter model) are discarded and the optimized configuration is recalculated using individual 3-parameter models (e.g. S+C+P) on each of the instance sizes. This verification may improve accuracy of the recommendation and mitigate noisy data (e.g., performance of one particular instance size bleeding into changing the fit on the other instance sizes). Once this new optimized configuration across instance sizes is determined, an associated instance size/worker number tuple is enqueued in 662. Stated differently, the new optimized configuration is added to the sequence of recommended allocations. A new recommended allocation is generated containing the updated cluster hardware in 664. In some embodiments, 664 includes providing the new recommended allocation from the sequence of recommended allocation to a user. In some embodiments, a user may opt to automatically implement the recommendations of optimization phase 650. In such embodiments, the new recommended allocation from the sequence of recommended allocations is automatically implemented at 664. Thus, using method 600, an optimized instance size and worker number may be determined, provided as a recommendation, and implemented automatically or by a user. Consequently, the cloud resources the job may be optimized for instance size and worker number. Thus, performance of the job may be improved using the recommended allocation of cloud resources.

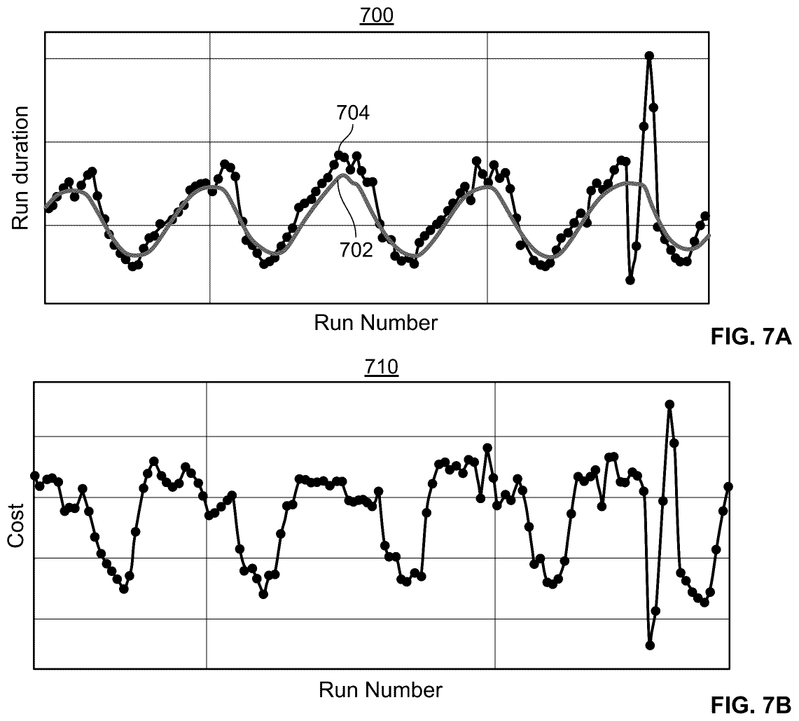

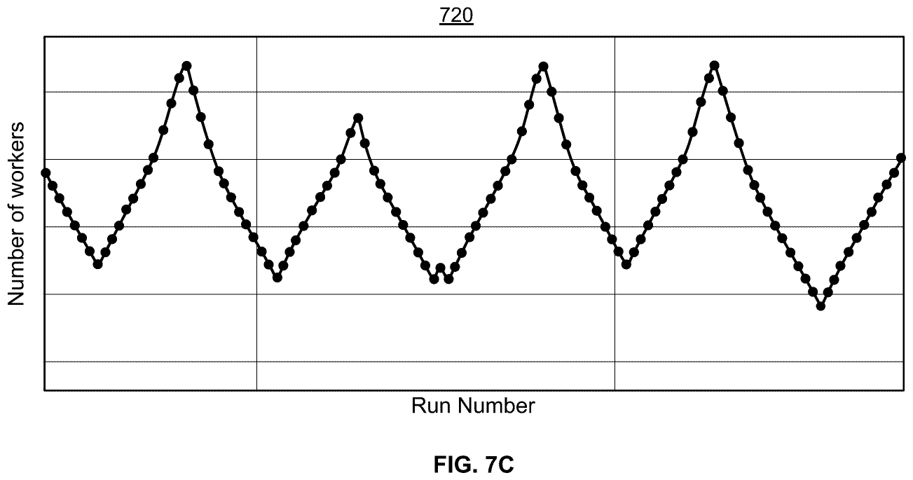

FIGS. 7A-7C depict graphs 700, 710, and 720 showing cloud resource allocation over multiple runs. In graph 700, depicting run duration as a function of time, periodicity has been identified (e.g., by prediction model 440) in run duration data 704 and is modeled by sinusoid 702. Periodicity may arise on various cadences (daily, weekly, monthly, seasonal, etc., or any combination thereof). In the embodiment shown, graph 700, graph 710, and graph 720 depict an hourly job (e.g., that evaluates visits to a website every hour). There is continuous variation in the size of this job (e.g., as user patterns vary during the day). For example, there may be more visits to a website during the day than at night, in which case the peaks in graph 700 may correspond to increased workload due to daytime web traffic. An allocation system that does not account for the periodicity of this job (e.g., manual allocation) may yield optimized clusters for an average run of the job, but in most cases would deviate from an optimized cluster at a given time. For each run, the cluster is likely to be over-provisioned or under-provisioned, and could accrue additional costs due to this throughout the day. Conversely, the periodic model of sinusoid 702 allows for the cloud resource allocation to be optimized dynamically as job demands change. Consequently, performance and efficiency may be improved.

Sinusoid 702 depicts an adaptive model that responds to the variation in cluster workload as the periodic elements of the job cycle through the multiple runs. In various embodiments, the model is used in conjunction with or as a portion of a learning phase, an optimizing phase, or any other appropriate optimization strategy. In the example shown, a three-parameter serial/parallel/inter-worker runtime model is augmented by adding an additional term T:

$$Runtime = S + P + C + T$$

where T denotes a time varying term that responds to the periodicity. Though shown as additive, terms may be combined in any other appropriate manner. For example, in some embodiments, T a multiplicative term:

$$Runtime = ( S + P + C ) T$$

The presence of the time-varying term allows the model to account for variations in runtime by choosing an appropriate functional form based on the cadence and type of periodicity. Without this term, the variations in runtime and dataset size may be grouped into the S, P and C terms, and increase their uncertainty and variance. This can lead to inaccurate predictions of optimal cluster configurations (e.g., while making extrapolations along the number-of-workers and cluster-size axes of optimization domain 430). The inclusion of the additional time-varying term reduces uncertainty in estimates of the S, P and C terms. This process also removes the need for manual correction of cluster configuration in response to periodic variations which can quickly become onerous, especially if the job is one of tens or hundreds of jobs, as is typically the case.

Recommendations made based on the model (e.g., determined in a manner analogous to 556 of FIG. 5B) account for this periodicity and the number of workers that are determined to be optimal cycle as a function of time. Graph 720 shows the fluctuation of the number of workers recommended as a function of time, while graph 710 shows cost as a function of time. As can be seen in graph 710, costs decrease regularly without diminishing performance during periods of increased workload. Thus, the allocation of cloud resources is optimized over time.

This approach of handling periodicity is powerful because the system recommends the optimized cluster size for the current size of the workload in near real-time. Without this correction, cloud resource allocations would often be too large or too small for the current size of the workload. Configuring the cluster for the current size of the workload decreases costs during periods of decreased workload, without increasing run time during periods of increased workload. Thus, the workload (e.g. job(s) 106) may be performed more inexpensively and rapidly than in a system which does not account for periodicity of the workload.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for optimizing a workflow provided by a computing platform to a cloud computing system, comprising:
extracting information from at least one log file for a job, the at least one log file for at least one run of the job; and
determining a recommended allocation of cloud resources for the job based on the information from the at least one log file, the recommended allocation of cloud resources including an incremental change from a most recent allocation of cloud resources.

2. The method of claim 1, wherein the incremental change comprises a change of at most ten percent or one unit of measurement for at least one of the cloud resources.

3. The method of claim 1, wherein the determining the recommended allocation further includes:
mapping the information to an intermediate fundamentals domain.

4. The method of claim 3, wherein the intermediate fundamentals domain includes at least one of a storage bandwidth, a network bandwidth, a CPU architecture, a clock rate, a virtual CPU, or a memory.

5. The method of claim 1, wherein the determining the recommended allocation further includes:
mapping the information to an optimization domain including at least one of a worker number, a worker virtual CPU number, a worker network bandwidth, a worker storage bandwidth, a worker clock rate, or a memory per worker.

6. The method of claim 5, wherein the determining the recommended allocation further includes:
providing the recommended allocation based on at least one of a cost, a run time, or a periodicity of the job.

7. The method of claim 6, wherein the run time is based on at least one of serial computation process costs, parallel computation process costs, inter-worker communication costs, network bandwidth runtime contributions, or periodic runtime variations of the job.

8. The method of claim 1, wherein determining the recommended allocation includes determining a sequence of allocations for the job and the recommended allocation is a first allocation of the sequence of allocations.

9. The method of claim 8, wherein an allocation of the sequence of allocations includes an incremental change from a previous allocation of the sequence of allocations.

10. A system, comprising:
a processor configured to:
extract information from at least one log file for a job, the at least one log file for at least one run of the job; and
determine a recommended allocation of cloud resources for the job based on the information from the at least one log file, the recommended allocation of cloud resources including an incremental change from a most recent allocation of cloud resources; and
a memory coupled to the processor and configured to provide the processor with instructions.

11. The system of claim 10, wherein the incremental change comprises a change of at most ten percent or one unit of measurement for at least one of the cloud resources.

12. The system of claim 10, wherein the processor is further configured to provide the recommended allocation based on at least one of a cost, a run time, or a periodicity of the job.

13. The system of claim 12, wherein the run time is based on at least one of serial computation process costs, parallel computation process costs, inter-worker communication costs, network bandwidth runtime contributions, or periodic runtime variations of the job.

14. The system of claim 10, wherein determining the recommended allocation includes determining a sequence of allocations for the job and the recommended allocation is a first allocation of the sequence of allocations.

15. The system of claim 14, wherein an allocation of the sequence of allocations includes an incremental change from a previous allocation of the sequence of allocations.

16. A computer program product embodied in a non-transitory computer readable medium and comprising computer instructions for:
extracting information from at least one log file for a job, the at least one log file for at least one run of the job; and
determining a recommended allocation of cloud resources for the job based on the information from the at least one log file, the recommended allocation of cloud resources including an incremental change from a most recent allocation of cloud resources.

17. The computer program product of claim 16, wherein the incremental change comprises a change of at most ten percent or one unit of measurement for at least one of the cloud resources.

18. The computer program product of claim 16, wherein the computer instructions further include computer instructions for:
providing the recommended allocation based on at least one of a cost, a run time, or a periodicity of the job.

19. The computer program product of claim 18, wherein the run time is based on at least one of serial computation process costs, parallel computation process costs, inter-worker communication costs, network bandwidth runtime contributions, or periodic runtime variations of the job.

20. The computer program product of claim 16, wherein determining the recommended allocation includes determining a sequence of allocations for the job and the recommended allocation is a first allocation of the sequence of allocations.
